(19) United States
(12) Patent Application Publication
(10) Pub. No.: US 2009/0101053 A1
(43) Pub. Date: Apr. 23, 2009

(54) Sewing machine and computer readable medium storing a sewing machine control program

(75) Inventors: Yoshio Nishimura, Nagoya-shi (JP); Hirokazu Hirose, Chiryu-shi (JP); Akie Ukai, Nagoya-shi (JP); Yoshinori Nakamura, Toyohashi-shi (JP); Masaki Shimizu, Toyoake-shi (JP); Satoru Makino, Nagoya-shi (JP); Kazumi Sai, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya-shi (JP)

(21) Appl. No.: 12/285,359

(22) Filed: Oct. 2, 2008

(30) Foreign Application Priority Data
Oct. 17, 2007 (JP) 2007-269784

(51) Int. Cl. D05B 69/14; G06F 17/30

(52) U.S. Cl. 112/221; 707/201

(57) ABSTRACT

A sewing machine including a main shaft; a motor driving the main shaft; a needle bar; a sewing needle attached to a lower end of the needle bar; a needle-bar drive mechanism driven by the main shaft and vertically moving the needle bar; a speed setter setting a rotational speed of the main shaft; a needle-position detector detecting a vertical position of the sewing needle or the needle bar; a main shaft speed detector; a motor controller; and a needle plate; wherein the motor controller executes at least either of a first control decelerating the main shaft below the set rotational speed when the lower end of the sewing needle is above the needle plate, or a second control accelerating the main shaft above the set speed when the lower end of the sewing needle is positioned below the needle plate based on detected results provided by the detectors.

### CROSS-REFERENCE TO RELATED APPLICATIONS

This application is based upon and claims the benefit of priority from the prior Japanese Patent Application 2007-269784, filed on Oct. 17, 2007, the entire contents of which are incorporated herein by reference.

### FIELD

The present disclosure relates to a sewing machine that is configured to position a lower end of a sewing needle above a needle plate for a longer time period compared to a time period in which the lower end of the sewing needle is positioned below the needle plate within one vertical reciprocating cycle of the sewing needle, especially when executing a free motion sewing operation. The present disclosure also relates to a computer readable medium that stores a control program to implement the above described features of the sewing machine.

### BACKGROUND

Sewing machines have conventionally allowed execution of a normal sewing operation and a so called free motion sewing operation. In the normal sewing operation, a workpiece cloth is fed by a feed dog that is moved above and below the upper surface of a needle plate provided at a sewing machine bed. In the free motion sewing operation, on the other hand, a user is allowed to manually move the workpiece cloth freely while prohibiting protrusion of the feed dog above the needle plate. When executing the free motion sewing operation in forming stitch patterns, a presser foot dedicated for free motion sewing is attached to a presser bar. Then, the user manually moves the workpiece cloth placed on the upper surface of the sewing machine bed according to guidance provided by indicators such as baselines drawn on the workpiece cloth prior to the execution of the sewing operation to form stitch patterns.

When the above described free motion sewing operation is executed by inexperienced users, it is preferable to allow the workpiece cloth to be moved slowly. Thus, in such cases, rotational speed of a main shaft, in other words, sewing speed is set to low speed by the user. When rotational speed of the main shaft is set to low speed, the lower end of the sewing needle stays below the needle plate for a relatively longer period of time. This consequently prolongs the time period in which the workpiece cloth is anchored in place by the penetration of the sewing needle. Thus, it is difficult to allow the workpiece cloth to be moved smoothly under the above described configuration.

One solution to the above problem may be to reduce the time period in which the lower end of the sewing needle is positioned below the needle plate to allow the workpiece cloth to be moved smoothly even when the main shaft is rotated at low speed. One example of such approach is disclosed, for example, in JP S62-60498 A (hereinafter referred to as reference document 1). Reference 1 discloses a method of driving an embroidery sewing machine, in which a transmission mechanism is provided that comprises a drive shaft and a follower shaft that are joined eccentrically by a joint. By driving a needle bar via the transmission mechanism, the time period in which the lower end of the sewing needle is positioned above the needle plate is prolonged and the time period in which the lower end of the sewing needle is positioned below the needle plate is reduced.

Since the embroidery sewing machine driven by the method disclosed in reference 1 requires provision of the transmission mechanism for driving the needle bar, the overall configuration for effecting needle bar movement becomes quite complex. The transmission mechanism has a pin protruding at a position eccentric with the tip of the drive shaft, and that is fitted into a groove defined on a disc provided at the base end of the follower shaft. The play between the pin and the groove of the disc thus causes unpleasant noise, which is another problem encountered in employing the transmission mechanism.

### SUMMARY

An object of the present disclosure is to provide a sewing machine that allows a desired stitch pattern to be formed neatly by facilitating the movement of the workpiece cloth during a free motion sewing operation without a complex mechanism for driving the needle bar. Another object of the present disclosure is to provide a computer readable medium that stores a computer program for implementing the above described features.

In one aspect of the present disclosure, a sewing machine includes a main shaft; a motor that drives the main shaft; a needle bar; a sewing needle attached to a lower end of the needle bar; a needle-bar drive mechanism driven by the main shaft and that vertically moves the needle bar; a speed setter that sets a rotational speed of the main shaft; a needle position detector that detects a vertical position of the sewing needle or the needle bar; a main shaft speed detector that detects the rotational speed of the main shaft; a motor controller that controls the motor; and a needle plate that is provided on a sewing machine bed and through which a lower end of the sewing needle penetrates; wherein the motor controller executes at least either of a first control or a second control based on detections provided by the needle position detector and the main shaft speed detector, the first control decelerating the rotational speed of the main shaft below the rotational speed set by the speed setter when the lower end of the sewing needle is positioned above the needle plate, the second control accelerating the rotational speed of the main shaft above the rotational speed set by the speed setter when the lower end of the sewing needle is positioned below the needle plate.

According to the above described configuration, the vertical position of the sewing needle or the needle bar is detected by the needle position detector. The rotational speed of the main shaft is detected by the main shaft speed detector. Based on the detection provided by the detectors, the motor controller executes at least either of the first or the second control. Thus, the rotational speed of the main shaft when the lower end of the sewing needle is above the needle plate is less than the rotational speed of the main shaft when the lower end of the sewing needle is below the needle plate. In other words, the time period in which the lower end of the sewing needle is positioned above the needle plate is greater than the time period in which the lower end of the sewing needle is positioned below the needle plate. Thus, the time period in which the workpiece cloth is anchored in place by the penetration of the sewing needle within a single vertical reciprocation of the sewing needle is relatively reduced to allow the workpiece cloth to be manually fed more smoothly to neatly form the desired stitch pattern. Moreover, the time period in which the sewing needle is anchored in place by the penetration of the sewing needle is managed through control of the motor controller that controls the rotation of the main shaft that drives the needle-bar drive mechanism, which simplifies the overall configuration.

In another aspect, a sewing machine of the present disclosure includes a main shaft; a motor that drives the main shaft; a needle bar; a sewing needle attached to a lower end of the needle bar; a needle-bar drive mechanism driven by the main shaft and that vertically moves the needle bar; a needle position detector that detects a vertical position of the sewing needle or the needle bar; a needle-bar release mechanism that deactivates the needle bar; a needle-bar release controller that controls the needle-bar release mechanism; a needle plate that is provided on a sewing machine bed and through which a lower end of the sewing needle penetrates; wherein the needle-bar release controller controls the needle-bar release mechanism based on detection provided by the needle position detector such that a time period in which the lower end of the sewing needle is positioned above the needle plate is longer than a time period in which the lower end of the sewing needle is positioned below the needle plate.

According to the above described configuration, the vertical position of the sewing needle or the needle bar is detected by the needle position detector. Based on the detected result, the needle-bar release controller controls the needle-bar release mechanism such that the time period in which the lower end of the sewing needle is positioned above the needle plate is greater than the time period in which the lower end of the sewing needle is positioned below the needle plate. Thus, the time period in which the workpiece cloth is anchored in place by the penetration of the sewing needle within a single vertical reciprocation of the sewing needle is relatively reduced to allow the workpiece cloth to be manually fed more smoothly to neatly form the desired stitch pattern.

### BRIEF DESCRIPTION OF THE DRAWINGS

Other objects, features and advantages of the present disclosure will become clear upon reviewing the following description of the illustrative aspects with reference to the accompanying drawings, in which,

FIG. 1 is a perspective view of a sewing machine according to one exemplary embodiment of the present disclosure;

FIG. 2 is a perspective view of a main shaft, a main shaft speed encoder, and a needle-position encoder;

FIG. 3 is a partial front view of a needle-bar release mechanism;

FIG. 4 is a partial side view of a needle-bar release mechanism;

FIG. 5A is a plan view of a main portion of the needle-bar release mechanism in seized state;

FIG. 5B is a plan view of a main portion of the needle-bar release mechanism in released state;

FIG. 5C is a side view of FIG. 5A;

FIG. 5D is a side view of FIG. 5B;

FIG. 6 is a block diagram of a control system of the sewing machine;

FIG. 7 is a flowchart of a sewing machine motor control program; and

FIG. 8 is a flowchart of a needle-bar release control program.

### DETAILED DESCRIPTION

A description will be given hereinafter on one exemplary embodiment of the present disclosure.

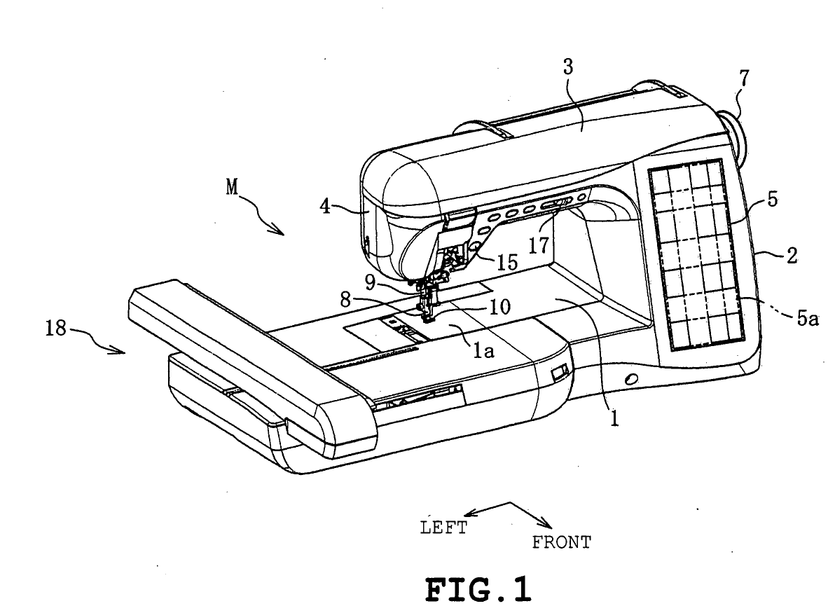

FIG. 1 illustrates a sewing machine M including a bed 1 corresponding to a sewing machine bed, a pillar 2 standing on the right end of bed 1, an arm 3 extending leftward over bed 1 from the upper end of pillar 2, and a head 4 defined at the left end of arm 3. Provided below a needle plate 1a provided at bed 1 are components such as a feed dog vertically-moving mechanism (not shown) that vertically moves a feed dog (not shown), a feed dog longitudinally-moving mechanism (not shown) that moves the feed dog longitudinally, a shuttle mechanism cooperating with a sewing needle 8 to form stitches, and an automatic thread cutter (not shown) that cuts at least a needle thread.

Bed 1 has a free arm that allows attachable/detachable attachment of an embroidery-frame drive unit 18 for sewing embroidery with an embroidery frame (not shown). Embroidery-frame drive unit 18 drives the embroidery frame in an X-direction (lateral direction) and a Y-direction (longitudinal direction) independently. During a free motion sewing operation, the embroidery-frame drive unit 18 is detached from the free arm.

Bed 1 has a feed dog vertically-moving lever at the rear sidewall which is exposed when embroidery-frame drive unit 18 is detached. Manual operation of the feed dog vertically-moving lever allows the feed dog to be switched between an active state where the workpiece cloth is fed by the feed dog moved above and below needle plate 1a, and an inactive state where the feed dog is lowered below needle plate 1a so as not to feed the workpiece cloth.

On the front face of pillar 2, a large color liquid crystal display (hereinafter referred to as color display) 5 is provided for displaying items such as a pattern selection screen for selecting various stitch patterns, a mode setting key 16 for switching mode settings between a normal sewing mode and a free motion sewing mode, and a function setting key for specifying settings for each type of sewing machine function. On the front face of color display 5, a touch panel 5a comprising matrix-aligned touch keys composed of transparent electrodes is provided for user operation.

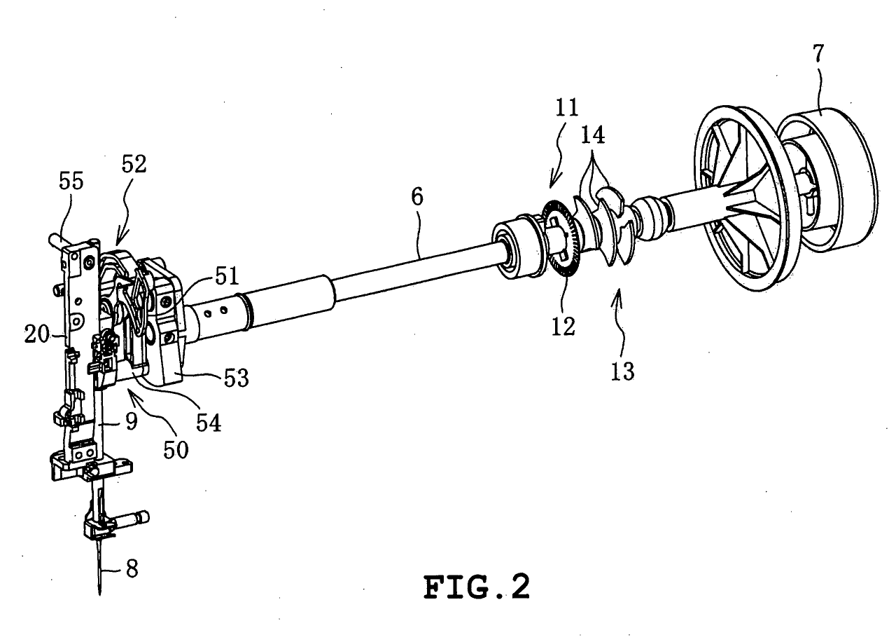

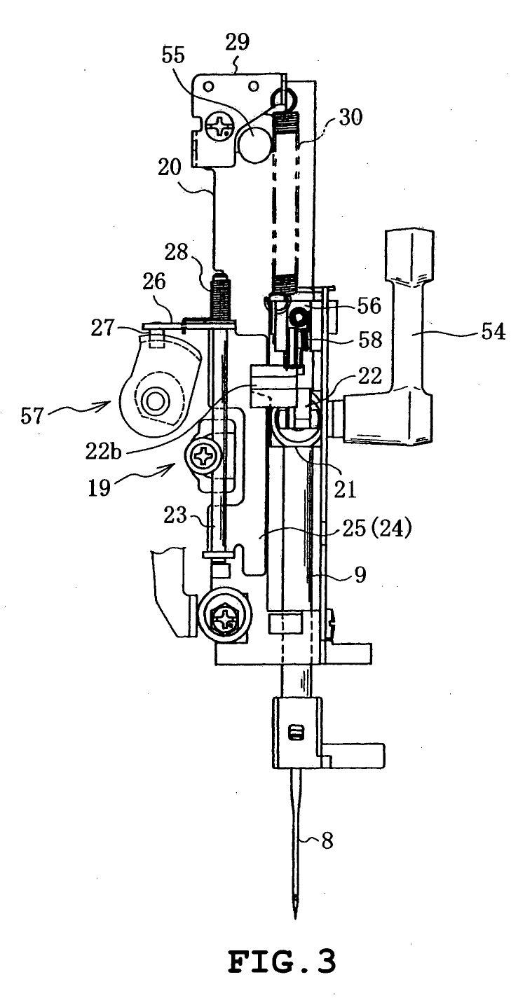

Referring to FIGS. 1 and 2, arm 3 includes a sewing machine motor 42, a main shaft 6, a hand pulley 7, a main shaft speed encoder 11, and a needle-position encoder 13. Main shaft 6 extends in the lateral direction and is driven by sewing machine motor 42 comprising a DC (Direct Current) motor. Hand pulley 7 is connected to main shaft 6 and allows manual rotation of main shaft 6. Main shaft speed encoder 11 detects a rotational speed of main shaft 6. Needle-position encoder 13 detects a vertical position of sewing needle 8 or a needle bar 9. Head 4 includes components such as a needle-bar drive mechanism 50, a needle-bar swing mechanism (not shown), a needle-bar release mechanism 19 (refer to FIG. 3), a thread take-up drive mechanism 52, and a presser-bar vertically moving mechanism not shown. Needle-bar drive mechanism 50 vertically moves needle bar 9 having sewing needle 8 attached to its lower end. Needle-bar swing mechanism swings needle bar 9 in a direction orthogonal to cloth feed direction. Needle-bar release mechanism 19 is capable of cutting off drive force exerted on needle bar 9 to render needle bar 9 inactive. Thread take-up drive mechanism 52 vertically moves a thread take-up 51 in synchronism with the vertical movement of needle bar 9. Presser-bar vertically moving mechanism vertically moves a presser bar (not shown) having a presser foot 10 attached to its lower end.

On the front face of arm 3, components such as a start/stop switch 15, a speed setting lever 17, and various types of switches are provided. Start/stop switch 15 instructs start/stop of sewing operation. Speed setting lever 17 sets the rotational speed of main shaft 6.

As can be seen in FIG. 2, main shaft speed encoder 11 and needle position encoder 13 are provided slightly to the right from the axial mid portion of main shaft 6. Main shaft speed encoder 11 is a rotational speed sensor that senses the rotational speed of main shaft 6 and comprises a disc 12 and a photo interrupter not shown. Disc 12 is mounted on main shaft 6 and has small radial slits defined on it. The photo interrupter is secured to a sewing machine frame not shown. Needle position encoder 13 is a rotational angle sensor that senses a rotational angle of main shaft 6 and is composed of 3 pieces of sectoral shutters 14 and a photo interrupter. The photo interrupter is secured to the sewing machine frame not shown. Disc 12 of main shaft speed encoder 11 and 3 pieces of shutters 14 rotate integrally with main shaft 6.

A description will now be given on needle-bar drive mechanism 50 based on FIGS. 2 to 4. A vertically oriented needle-bar support 20 is provided at the substantial center of head 4. The upper end of needle-bar support 20 is secured laterally swingably to the sewing machine frame (not shown) by a pivot pin 55. Needle bar 9 having sewing needle 8 attachably/detachably attached to its lower end is supported vertically movably by needle-bar support 20. Main shaft 6, on the other hand, has a thread take-up crank 53 secured at its left end. Thread take-up crank 53 has the upper end of a needle-bar crank rod 54 connected rotatably to it, the needle-bar crank rod 54 having a needle-bar clamp 21 rotatably connected to its lower end. Needle-bar clamp 21 is slidably supported by needle bar 9.

The upper end of a vertically extending swing element 22 is supported swingably by a securing element 56 secured on needle bar 9. At the lower end of swing element 22 on the other hand, an engagement protrusion 22a is provided that is pressed in engagement with an engagement recess 21a provided at needle-bar clamp 21 by a torsion spring 58. Needle-bar drive mechanism 50 being configured as described above rotates main shaft 6 by sewing machine motor 42 by which thread take-up crank 53 is rotated to vertically drive needle-bar clamp 21 connected to the lower end of needle-bar crank rod 54. Swing element 22 being engaged with needle-bar clamp 21 is supported by securing element 56 secured to needle bar 9. Thus, needle bar 9 is vertically moved integrally with the vertical movement of needle-bar clamp 21.

Next, a description will be given on needle-bar release mechanism 19.

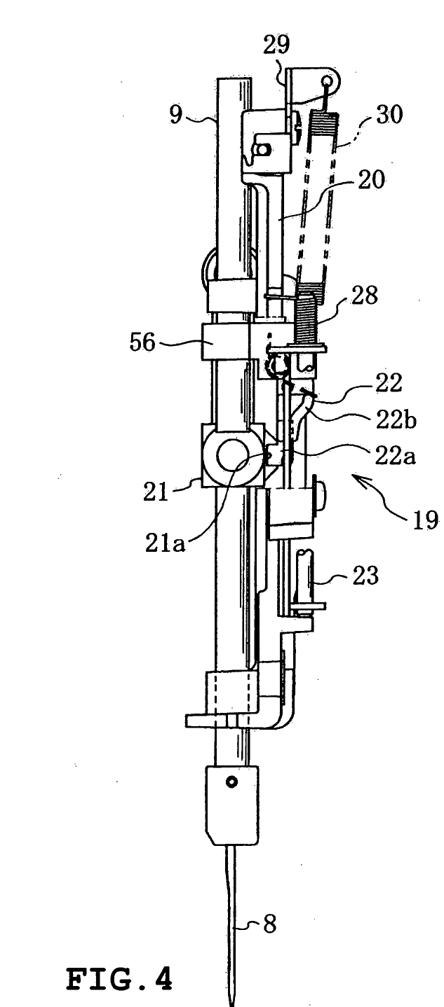

Referring now to FIGS. 3 and 4, on the lower left side of needle-bar support 20, a vertically oriented support shaft 23 is supported to which a cut-off plate 24 is further swingably supported. Cut-off plate 24 is provided integrally with an activating plate 25 and a drive lever 26. Activating plate 25 is sized to correspond to the lower left half of needle-bar support 20.

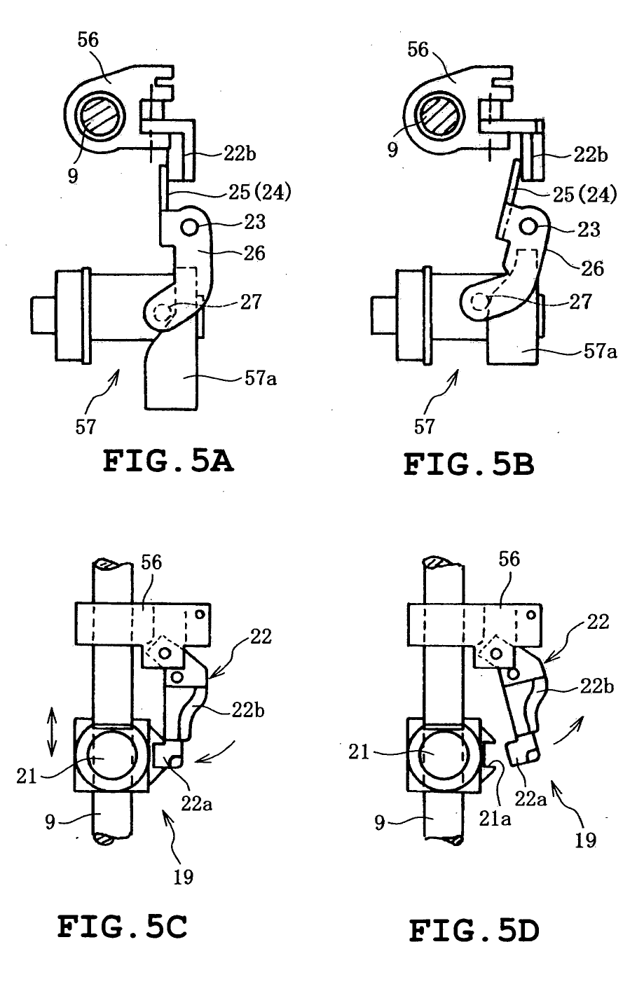

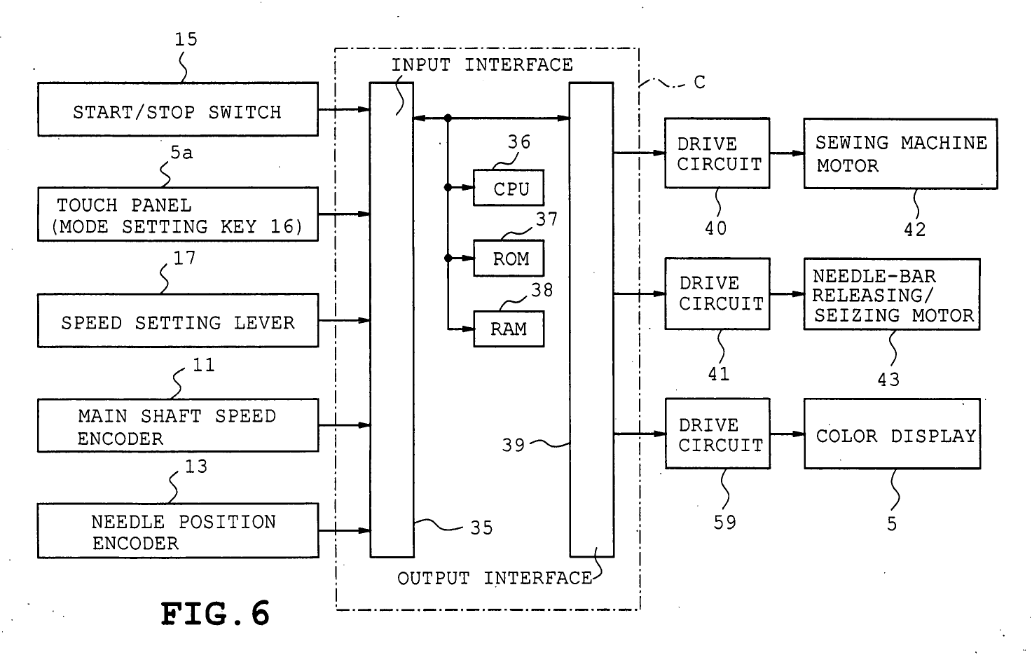

Drive lever 26 has secured on its terminating end an engagement pin 27 which is capable of abutting a cam 57a of a cam element 57 from the rear side. Cam element 57 is rotated by a needle-bar releasing/seizing step motor 43 (refer to FIG. 6) secured on the sewing machine frame. Cut-off plate 24 is biased counterclockwise in plan view by the elasticity of a coil spring 28 so that activating plate 25 may be engaged with an engagement protrusion 22b of swing element 22 from the rear side. During the normal sewing operation, needle bar 9 is vertically moved integrally with the vertical movement of needle-bar clamp 21 as described in FIGS. 5A and 5C. In contrast, in order to release needle-bar 9 to inactivate its vertical movement, needle-bar releasing/seizing step motor 43 is driven to rotate cam element 57 clockwise. At this instance, as can be seen in FIGS. 5B and 5D, engagement pin 27 in abutment with cam 57a is moved rearward to cause cut-off plate 24 to rotate clockwise in plan view. Thus, engagement protrusion 22a of swing element 22 is detached from engagement recess 21a of needle-bar clamp 21 via engagement protrusion 22b engaged with activating plate 25.

Consequently, needle bar 9 is moved to and retained at its uppermost position by the elasticity of coil spring 30 engaged with a spring receiver 29 mounted on needle-bar support 20. Thus, even if needle-bar clamp 21 is vertically moved by rotation of main shaft 6, needle bar 9 is retained at its uppermost position without being vertically moved.

On the other hand, when cam element 57 is rotated counterclockwise by needle-bar releasing/seizing step motor 43, engagement protrusion 22a of swing element 22 is moved to a position capable of engaging with engagement recess 21a of needle-bar clamp 21. When needle-bar clamp 21 is moved to its uppermost position under such state, engagement protrusion 22a and engagement recess 21a re-establish their engagement to regain the vertical movement of needle bar 9.

Next, a description will be given on control system of sewing machine M.

Referring to FIG. 6, a controller C is configured by components such as a microcomputer comprising a CPU 36, a ROM 37, and a RAM 38, and an input interface 35 and an output interface 39, which are connected to the microcomputer by elements such as a data bus. Input interface 35 establishes connections with components such as start/stop switch 36, a touch panel 5a, speed setting lever 17, main shaft speed encoder 11, and needle position encoder 13. Output interface 39, on the other hand, establishes connections with components such as sewing machine motor 42, needle-bar releasing/seizing step motor 43, and color display 5 via drive circuits 40, 41, and 59, respectively. Sewing machine motor 42 controls its rotational speed by PWM (Pulse Width Modulation), in other words, by altering the duty ratio of sewing machine motor 42 based on instructions provided by controller C.

ROM 37 pre-stores control programs such as a control program for executing normal sewing operations, a control program for sewing embroidery patterns based on embroidery data, a display control program for displaying various types of information on color display 5, and a sewing machine motor control program for controlling sewing machine motor 42 based on detection provided by needle position encoder 13 and main shaft speed encoder 11.

When sewing machine motor control program is started, controller C controls sewing machine motor 42 to execute either a first control or a second control based on the detection provided by needle position encoder 13 and main shaft speed encoder 11. The first control is a control executed to decelerate the rotational speed of main shaft 6 below the set speed when main shaft 6 is rotated at low speed and the lower end of sewing needle 8 is above needle plate 1a. The second control is a control executed to accelerate the rotational speed of main shaft 6 above the set speed when main shaft 6 is rotated at low speed and the lower end of the sewing needle 8 is below needle plate 1a.

ROM 37 includes a sewing data memory that pre-stores sewing data of multiple stitch patterns. When executing a sewing operation with sewing machine M, the sewing data of the stitch pattern selected by the user is read from the sewing data memory and is stored in a data memory allocated in RAM 38. RAM 38 includes data memory for reading and storing sewing data to be sewn which was retrieved from data memory of ROM 37, and various work memory.

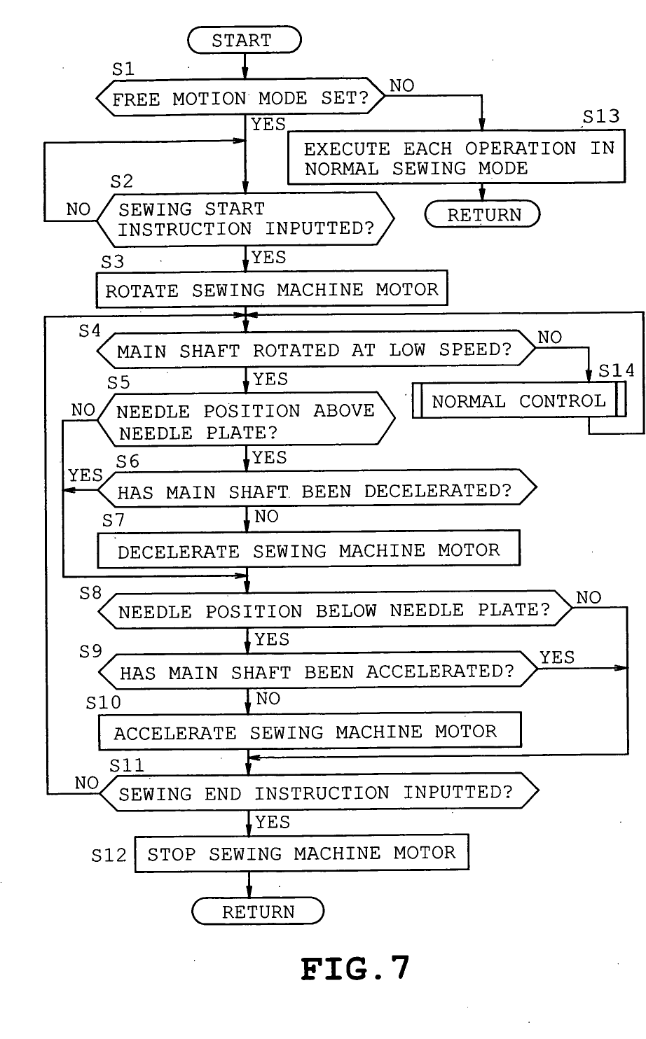

Next, a description will be given on sewing machine motor control executed by controller C based on FIG. 7. Reference symbols Si (i=1, 2, . . . ) indicate each step of the control flow.

The sewing machine motor control is started when power of sewing machine M is turned on. As the first step of the control, controller C determines whether or not the free motion mode has been set by operation of mode setting key 16 displayed on touch panel 5a (S1). If the free motion mode has been set (S1: Yes), controller C determines whether or not an instruction has been inputted to start the sewing operation, in other words, determination is made as to whether or not sewing operation start has been instructed by start/stop switch 15 (S2). If the free motion mode has not been set, in other words, if the normal sewing mode has been set (S1: No), controller C executes operations required in normal sewing mode (S13) and the control is repeated from S1. The free motion mode may be set by selecting a free motion pattern from the pattern selection screen instead of being set through operation of mode setting key 16. Mode setting key 16 may be provided as an independent switch instead being displayed on touch panel 5a.

Next, when sewing start has been instructed (S2: Yes), controller C rotates sewing machine motor 42 (S3) at a speed corresponding to the rotational speed of main shaft 6 set by speed setting lever 17 and controller C thereafter determines whether or not main shaft 6 is being rotated at low speed (S4). If main shaft 6 is being rotated at low speed below 200 rpm (rotations per minute), for example (S4: Yes), controller C detects the vertical position of sewing needle 8 through needle position encoder 13 and determines whether the lower end of sewing needle 8 is above or below needle plate 1a (S5). If main shaft 6 is not rotated at low speed but is rotated at or above 200 rpm (S4: No), normal control is executed (S14) and the control proceeds to S4.

If needle position, that is, the lower end of sewing needle 8 is above needle plate 1a (S5: Yes), controller C determines whether or not rotational speed detected by main shaft speed encoder 11 at which main shaft 6 is being rotated is the result of deceleration, in other words, whether or not sewing machine motor 42 has been decelerated at a later described S7 (S6). If not decelerated (S6: No), the rotational speed of sewing machine motor 42 is decelerated by a predetermined speed, for example, by 30% of detected speed (S7). Regardless of whether the needle position is below needle plate 1a (S5: No) or above needle plate 1a, if rotational speed of sewing machine motor 42 has been decelerated (S6: Yes), controller C proceeds to S8.

Next, controller C detects the vertical position of sewing needle 8 through needle position encoder 13 and determines whether or not the needle position is above or below needle plate 1a (S8). If the needle position is below needle plate 1a (S8: Yes), controller C determines whether or not rotational speed detected by main shaft speed encoder 11 at which main shaft 6 is being rotated is the result of acceleration, in other words, whether or not sewing machine motor 42 has been accelerated at a later described S10 (S9). If not accelerated (S9: No), the rotational speed of sewing machine motor 42 is accelerated by a predetermined speed, for example by 30% of detected speed (S10). Regardless of whether the needle position is above needle plate 1a (S8: No) or below needle plate 1a, if rotational speed of sewing machine motor 42 has been accelerated (S9: Yes), controller C proceeds to S11.

Next, controller C determines whether or not an instruction has been inputted to end the sewing operation, in other words, whether or not end of sewing operation has been instructed by start/stop switch 15 (S11). If end of sewing operation has been instructed (S11: Yes), controller C stops sewing machine motor 42 (S12) and repeats the control from S1. If the end of sewing operation has not been instructed (S11: No), controller C proceeds to S4.

Next, a description will be given on operation and effect of the above described sewing machine M.

When executing the free motion sewing operation, sewing operation is started after the sewing mode has been switched to the free motion sewing mode by mode setting key 16. Then, the vertical position of sewing needle 8 and needle bar 9 are detected by needle position encoder 13 and the rotational speed of main shaft 6 is detected by main shaft speed encoder 11.

Based on the detection provided by encoders 13 and 11, controller C controls sewing machine motor 42 to decelerate the rotational speed of main shaft 6 while the lower end of sewing needle 8 is above needle plate 1a, and accelerate the rotational speed of main shaft 6 while the lower end of sewing needle 8 is below needle plate 1a. Consequently, the time period in which the lower end of sewing needle 8 is positioned above needle plate 1a becomes greater than the time period in which the lower end of sewing needle 8 is positioned below needle plate 1a. Thus, time period in which sewing needle 8 penetrates the workpiece cloth is relatively reduced, and the user is allowed to manually move the workpiece cloth more smoothly.

As described above, needle-position encoder 13, main shaft speed encoder 11 and controller C are provided to allow sewing machine motor 42 to be controlled by controller C based on the results of detection provided by needle position encoder 13 and main shaft speed encoder 11 such that the rotational speed of main shaft 6 is decelerated while the lower end of sewing needle 8 is above needle plate 1a and accelerated while the lower end of sewing needle 8 is below needle plate 1a. Thus, the time period in which sewing needle 8 penetrates the workpiece cloth within a single vertical reciprocation of sewing needle 8 can be reduced during the free motion sewing operation.

As a result, the workpiece cloth can be manually moved more smoothly during the free motion sewing operation where main shaft 6 is rotated at low speed to allow the desired stitch pattern to be formed neatly. Moreover, since duration of sewing needle penetration of workpiece cloth is reduced through control of controller C that controls sewing machine motor 42 exerting rotation of main shaft 6 which in turn drives the needle-bar drive mechanism, needle-bar drive mechanism can be provided in a simple configuration. Since needle position encoder 13 comprises a rotational angle sensor that senses rotational angle of main shaft 6, whereas main shaft speed encoder 11 comprises a rotational speed sensor that senses rotational speed of main shaft 6, both encoders 11 and 13 can be provided in a simple and low cost configuration.

A description will be given hereinafter on partial modifications of the above described exemplary embodiment.

Instead of executing both of the first and second controls, only either of the two controls may be executed to simplify the configuration of the sewing machine motor control program.

Instead of controlling sewing machine motor 42 by controller C, needle-bar release mechanism 19 may be controlled so that the time period in which sewing needle 8 is positioned above needle plate 1a becomes greater than the time period in which sewing needle 8 is positioned below needle plate 1a based on the detection of needle position encoder 13.

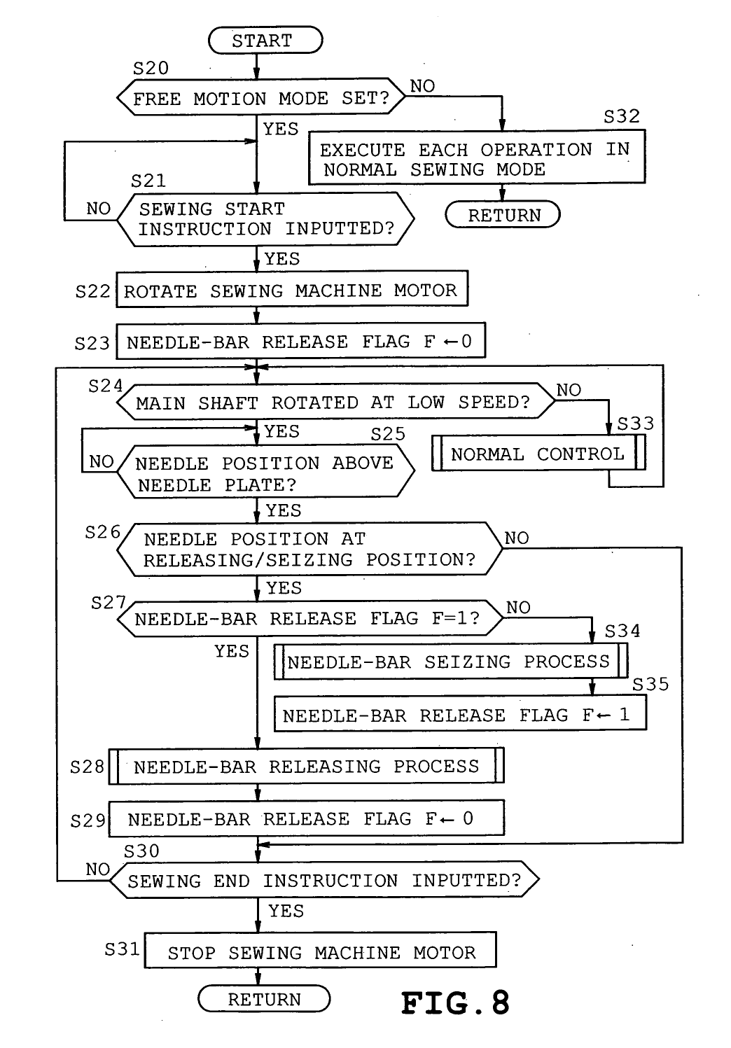

A flowchart of needle-bar releasing/seizing control executed by controller C will be described hereinafter with reference to FIG. 8. Reference symbols Si (i=20, 21 . . . ) indicate each step of the control flow.

The needle-bar releasing/seizing control is started when power of sewing machine M is turned on. As the first step of the control, controller C determines whether or not the free motion mode has been set (S20) by mode setting key 16. If the free motion mode has been set (S20: Yes), controller C determines whether or not an instruction has been inputted to start the sewing operation, in other words, determination is made as to whether or not sewing operation start has been instructed by start/stop switch 15 (S21). If the free motion mode has not been set, in other words, if normal sewing mode has been set (S20: No), controller C executes operations required in the normal sewing mode (S32) and the control is repeated from S20.

Next, when sewing start has been instructed (S21: Yes), controller C rotates sewing machine motor 42 (S22) at a speed corresponding to the rotational speed of main shaft 6 set by speed setting lever 17 and a needle-bar release flag F is set to 0 (S23). Needle-bar release flag F is a flag that indicates whether or not needle bar 9 is to be released in the next rotational period of main shaft 6, and if needle bar 9 is to be released in the next rotational period, needle-bar release flag F is set to 1.

Next, controller C determines whether or not main shaft 6 is being rotated at low speed (S24). If main shaft 6 is being rotated at low speed below 200 rpm, for example (S24: Yes), controller C detects the vertical position of sewing needle 8 through needle position encoder 13 and determines whether or not the lower end of sewing needle 8 is above needle plate 1a (S25). If main shaft 6 is not rotated at low speed but is rotated at or above 200 rpm (S24: No), controller C executes normal control (S33) and the control proceeds to S24.

If the needle position is above needle plate 1a (S25: Yes), controller C detects the needle position by needle position encoder 13 and determines whether or not the needle position is in a needle-bar releasing/seizing position (S26). If the needle position is in the needle-bar releasing/seizing position (S26: Yes), and if needle-bar release flag F is set to 1 (S27: Yes), controller C executes needle-bar release process (S28) by driving needle-bar releasing/seizing step motor 43 and needle-bar release flag F is set to 0 (S29) thereafter. If the needle position is not in needle-bar releasing/seizing position (S26: No), controller C proceeds to S30. Also even if needle position is in needle-bar releasing/seizing position, if needle-bar release flag F is set to 0 (S27: No), controller C executes needle-bar seizing process (S34) by driving needle-bar releasing/seizing step motor 43, and needle-bar release flag F is set to 1 (S35) thereafter. Then, the controller C proceeds to S30.

Next, controller C determines whether or not an instruction has been inputted to end the sewing operation, in other words, whether or not end of sewing operation has been instructed by start/stop switch 15 (S30). If the end of the sewing operation has been instructed (S30: Yes), controller C stops sewing machine motor 42 (S31) and repeats S20 onwards. If the end of sewing operation has not been instructed (S30: No), controller C proceeds to S24.

By providing needle-bar release mechanism 19 capable of inactivating needle bar 9, controller C is allowed to control needle-bar release mechanism 19 so that the time period in which the lower end of sewing needle 8 is above needle plate 1a is greater than the time period in which the lower end of sewing needle 8 is below needle plate 1a based on the detection provided by needle position encoder 13 to provide the effects offered by the earlier described exemplary embodiment.

Main shaft speed encoder 11 and needle position encoder 13 provided on main shaft 6 may be provided on a lower shaft-disposed laterally inside bed 1.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A sewing machine, comprising:
a main shaft;
a motor that drives the main shaft;
a needle bar;
a sewing needle attached to a lower end of the needle bar;
a needle-bar drive mechanism driven by the main shaft and that vertically moves the needle bar;
a speed setter that sets a rotational speed of the main shaft;
a needle position detector that detects a vertical position of the sewing needle or the needle bar;
a main shaft speed detector that detects the rotational speed of the main shaft;
a motor controller that controls the motor; and
a needle plate that is provided on a sewing machine bed and through which a lower end of the sewing needle penetrates;
wherein the motor controller executes at least either of a first control or a second control based on detections provided by the needle position detector and the main shaft speed detector, the first control decelerating the rotational speed of the main shaft below the rotational speed set by the speed setter when the lower end of the sewing needle is positioned above the needle plate, the second control accelerating the rotational speed of the main shaft above the rotational speed set by the speed setter when the lower end of the sewing needle is positioned below the needle plate.

2. A sewing machine, comprising:
a main shaft;
a motor that drives the main shaft;
a needle bar;
a sewing needle attached to a lower end of the needle bar;
a needle-bar drive mechanism driven by the main shaft and that vertically moves the needle bar;
a needle position detector that detects a vertical position of the sewing needle or the needle bar;
a needle-bar release mechanism that deactivates the needle bar;
a needle-bar release controller that controls the needle-bar release mechanism; and
a needle plate that is provided on a sewing machine bed and through which a lower end of the sewing needle penetrates;
wherein the needle-bar release controller controls the needle-bar release mechanism based on detection provided by the needle position detector such that a time period in which the lower end of the sewing needle is positioned above the needle plate is greater than a time period in which the lower end of the sewing needle is positioned below the needle plate.

3. The sewing machine according to claim 1, wherein the needle position detector comprises a rotational angle sensor that senses a rotational angle of the main shaft.

4. The sewing machine according to claim 1, wherein the main shaft speed detector comprises a rotational speed sensor that senses the rotational speed of the main shaft.

5. The sewing machine according to claim 2, wherein the needle position detector comprises a rotational angle sensor that senses a rotational angle of the main shaft.

6. A computer readable medium storing a control program for controlling a sewing machine including a main shaft; a motor that drives the main shaft; a needle bar; a sewing needle attached to a lower end of the needle bar; a needle-bar drive mechanism driven by the main shaft and that vertically moves the needle bar; a speed setter that sets a rotational speed of the main shaft; a needle position detector that detects a vertical position of the sewing needle or the needle bar; a main shaft speed detector that detects the rotational speed of the main shaft; a motor controller that controls the motor; a needle plate that is provided on a sewing machine bed and through which a lower end of the sewing needle is penetrated; the control program stored in the computer readable medium, comprising:
instructions for executing at least either of a first control or a second control based on detections provided by the needle position detector and the main shaft speed detector, the first control decelerating the rotational speed of the main shaft below the rotational speed set by the speed setter when the lower end of the sewing needle is positioned above the needle plate, the second control accelerating the rotational speed of the main shaft above the rotational speed set by the speed setter when the lower end of the sewing needle is positioned below the needle plate.

7. A computer readable medium storing a control program for controlling a sewing machine including a main shaft; a motor that drives the main shaft; a needle bar; a sewing needle attached to a lower end of the needle bar; a needle-bar drive mechanism driven by the main shaft and that vertically moves the needle bar; a needle position detector that detects a vertical position of the sewing needle or the needle bar; a needle-bar release mechanism that deactivates the needle bar; a needle-bar release controller that controls the needle-bar release mechanism; a needle plate that is provided on a sewing machine bed and through which a lower end of the sewing needle is penetrated; the control program stored in the computer readable medium, comprising:
instructions for controlling the needle-bar release mechanism based on detection provided by the needle position detector such that a time period in which the lower end of the sewing needle is positioned above the needle plate is greater than a time period in which the lower end of the sewing needle is positioned below the needle plate.
